(19) United States
(12) Patent Application Publication
(10) Pub. No.: US 2018/0349816 A1
(43) Pub. Date: Dec. 6, 2018

(54) Apparatus And Method For Dynamic Risk Assessment

(71) Applicant: General Electric Company, Schenectady, NY (US)

(72) Inventors: Louise Pattison, Roanoke, VA (US); Chris Defalco, Roanoke, VA (US); Jason Cline, Roanoke, VA (US); Donald Rozette, Roanoke, VA (US)

(21) Appl. No.: 15/608,755

(22) Filed: May 30, 2017

(51) Int. Cl. G06Q 10/06

(52) U.S. Cl. CPC G06Q 10/0635

(57) ABSTRACT

The present invention is directed to dynamically assessing risk for industrial or other assets and taking actions once this is determined. In some aspects, a determination is made based on where on a scale of risk an asset is operating. In other aspects, a ranking of all assets is made, and various actions are taken based upon the ranking. For example, some assets may be need to be serviced before others, and the ranking may specify the order of service.

### BACKGROUND OF THE INVENTION

### Field of the Invention

The subject matter disclosed herein generally relates to risk assessment and, more specifically, to determining where on a risk assessment scale an asset is operating.

### Brief Description of the Related Art

Various types of industrial assets are used in various locations. For example, in factories, different types of machines such as grinders, furnaces, saws, and other fabrication tools are used. Other types of assets include machinery such as vehicles. For instance, a rental car company views their vehicles as assets.

Assets sometimes break down, fail, or otherwise become inefficient in their operation. Various types of risk are associated with these failures including financial, production, environmental, or safety to mention a few factors. For example, the risk associated with the failure of a nuclear reactor may include huge monetary damages, massive environmental impacts, and critical health and safety concerns. In other examples, the failure of a component on a vehicle (e.g., a tire), may result in loss of life or serious injury to the driver of the vehicle.

Previous systems have in some ways visualized risk to the operators or owners of assets. However, these previous approaches suffered from shortcomings and these shortcomings have resulted in some user dissatisfaction with previous approaches.

### BRIEF DESCRIPTION OF THE INVENTION

The present invention is directed to dynamically assessing risk for industrial or other assets and taking actions once this risk is determined. In some aspects, a determination is made as to where on a scale of risk an asset is operating. In other aspects, a ranking of risks for multiple assets is made, and various actions are taken based upon the ranking. For example, some assets may be need to be serviced before others, and the ranking may specify or indicate the order of service.

In many of these embodiments, a first characteristic of a first industrial asset is monitored. A maximum risk associated with failure of the first industrial asset and a minimum risk associated with failure of the first industrial asset are determined. The maximum risk and the minimum risk define a continuous scale of risk values. In aspects, the maximum risk and the minimum risk comprise an evaluation of one or more factors such as environmental factors, production factors, safety factors, and financial factors. Other examples of risk factors are possible.

Based upon the monitored first characteristic, a current risk at which the first industrial asset is operating, as well as a location on the scale representing the current risk at which the first industrial asset is operating are determined. The current risk is then rendered or presented on the scale to a user (e.g., on a screen of an electronic device). The current risk is dynamically re-calculated and the location on the scale of the current risk at which the first industrial asset is operating is adjusted as new values of the first characteristic are received. In some aspects, the current risk of the asset as applied to the scale is rendered as a visual image to a user, such as a display on a computer or smartphone device. Other examples of devices are possible with displays are possible.

An action is then taken based upon the location of the current risk on the scale. In one example, taking the action comprises prioritizing a first action with respect to the first industrial asset and a second action with respect to the second industrial asset. Other examples of actions are possible.

In other aspects, a second characteristic of a second industrial asset is also monitored. A determination is made where on the scale the second asset is operating. This position can also be presented to the user at a user device (along with the position where the first industrial asset is operating).

In examples, the first characteristic may be a speed, a pressure, a dimension, a temperature, and a time. Other examples of characteristics are possible.

In one example, the first asset is an industrial machine deployed in a factory. Other examples of assets are possible.

In other of these embodiments, an apparatus that is configured to determine risk at which an industrial asset is operating includes an interface with an input and an output. The input is configured to receive a first characteristic of a first industrial asset that is monitored by a first sensor. The apparatus also has a database that is configured to store a data structure, and the data structure that includes a maximum risk associated with failure of the first industrial asset and a minimum risk associated with failure of the first industrial asset. The maximum risk and the minimum risk define a continuous scale.

Further, the apparatus has a control circuit that is coupled to the interface, the control circuit is configured to determine a current risk at which the first industrial asset is operating and a location on the scale representing the current risk at which the first industrial asset is operating. The current risk is presented to the user on the scale via the output of the interface. The control circuit is further configured to dynamically re-calculate the current risk and adjust the location on the scale of the current risk at which the first industrial asset is operating as new values of the first characteristic are received at the input of the interface. The control circuit is configured to determine an action based upon the placement of the current risk on the scale. The action is communicated to a user via the output of the interface.

### BRIEF DESCRIPTION OF THE DRAWINGS

For a more complete understanding of the disclosure, reference should be made to the following detailed description and accompanying drawings wherein:

FIG. 1 comprises a block diagram showing a system allowing the assessment of risk associated with industrial assets according to various embodiments of the present invention;

FIG. 2 comprises a flowchart showing one approach for determining and displaying the risk associated with the operation of industrial assets according to various embodiments of the present invention;

FIG. 3 comprises a block diagram of a processing apparatus according to various embodiments of the present invention;

FIG. 4 comprises a diagram of an example of a risk scale according to various embodiments of the present invention;

FIG. 5 comprises a chart showing one approach to converting or mapping sensed or monitored readings of industrial assets into scaled values according to various embodiments of the present invention;

FIG. 6 comprises a diagram of another example of a risk scale according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The present approaches are directed to determining where on a risk scale an asset is operating. Depending upon where the asset is operating (and in some instances, where the asset is operating with respect to other aspects), various actions can be taken.

As used herein, “risk” defines the consequences, timing, and other characteristics of an asset failure. Risk may be associated with environmental, production, safety, or financial concerns. Risk may be associated with a risk of failure, or a risk that the asset becomes inefficient in operation. Risk can be assigned a number and can be positioned on a relative scale (e.g., from low to high). In one example, financial risk may be a dollar value. A maximum risk may be associated with the consequences of a complete failure (e.g., a very high dollar amount), while a minimum risk may be associated with an asset where all risk mitigation approaches are in place (e.g., a low or zero dollar amount). Environmental risks with respect to a nuclear reactor include a maximum risk (e.g., a complete melt down of the reactor) and a minimum risk (normal operation of the reactor). It will be appreciated that various types of risk can be combined together. As mentioned, the minimum and maximum risk determine a scale.

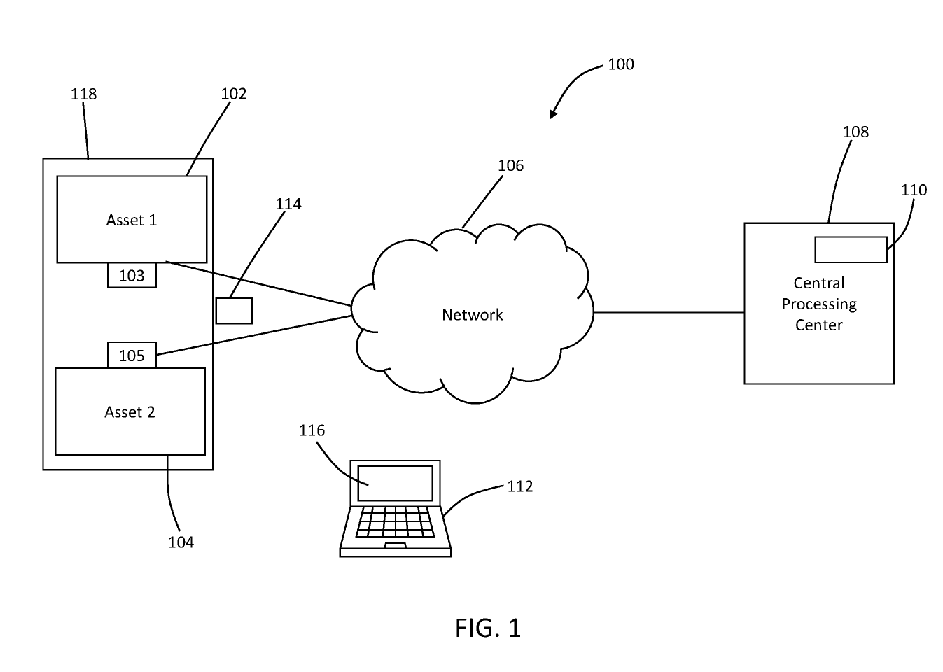

Referring now to FIG. 1, one example of a system 100 that dynamically determines and displays the risk associated with the operation of industrial assets is described. The system 100 includes an installation 118, industrial assets 102 and 104 (having sensors 103 and 105), a communication network 106, a central processing center 108 (with an apparatus 110), and a user device 112 with a graphical display 116. The installation 118 may be any grouping of one or more industrial assets.

In some aspects, the installation 118 may be a factory, school, campus, office building, or other facility housing industrial assets. Other examples of installations are possible.

The installation 118 includes a first asset 102 and a second asset 104. Although two assets are shown here, it will be appreciated that any number of assets can be used (e.g., one asset, or more than two assets). The first asset 102 and second asset 104 may be any type of industrial machine or device. In some examples, the first asset 102 and second asset 104 may be a wind turbine, nuclear reactor, boiler, computer, or motor vehicle. Other examples of industrial machines are possible.

The assets 102, 104 operate at or within the installation 118. In some aspects, the assets 102, 104 constantly collect data related to various characteristics (e.g., speed, pressure, dimension, time, and temperature) using sensors 103 and 105. The data may include sensor values 114, which may be numerical values related to the characteristics sensed by the sensors 103, 105. For example, the data may include a numerical value of temperature in degrees Celsius. The sensor values 114 are sent to the network 106.

The assets 102, 104 may include transceiver circuits that transmit and/or receive information or messages to/from the network 106. In other examples, the assets 102, 104 couple to separate transceiver circuits that are physically separate from the assets 102, 104.

The communication network 106 may be any network or combination of networks. In examples, the network 106 may be the cloud, the internet, cellular networks, local or wide area networks, or any combination of these (or other) networks. The network 106 may include various electronic devices (e.g., routers, gateways, and/or processors to mention a few examples).

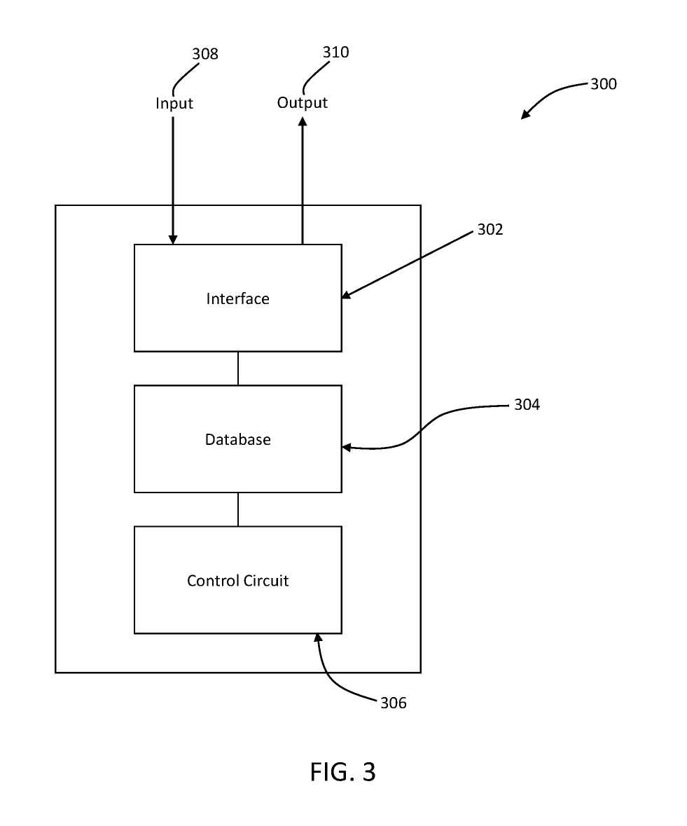

The apparatus 110 is housed within the central processing center 108 and includes in some aspects a control circuit, database, and interface. In aspects, the apparatus 110 is the apparatus 300 described below with respect to FIG. 3. The apparatus 110 is configured to, based upon monitored characteristics, determine a current risk at which industrial assets 102, 104 are operating and a location on a scale representing the current risk at which the industrial assets 102, 104 are operating. The apparatus 110 is configured to dynamically re-calculate the current risk and adjust the location on the scale of the current risk at which first industrial assets are operating as new values of the characteristics are received.

The user device 112 is any type of device that displays data in a visually accessible manner to a user, such as a risk scale graphic. In examples, the device 112 is a computer or smartphone. Other examples are possible. It will be appreciated that the user display device 112 may be deployed outside the installation 118 (as shown in FIG. 1), but may also be deployed within the installation 118. For example, a user with a smartphone may desire to view the risk scale graphic as the user walks through the installation 118. In other examples, the user display device 112 is a personal computer deployed at the installation 118 (e.g., at a factory, school, or business).

In one example of the operation of the system of FIG. 1, a first characteristic of a first industrial asset 102 is monitored, and a maximum risk associated with failure of the first industrial asset 102 and a minimum risk associated with failure of the first industrial asset 102 are determined. The maximum risk and the minimum risk define a continuous scale of risk values. For example, the continuous scale of risk values may be designated as integer tick mark labels from 0 to 10, with 0 corresponding to minimum risk of asset failure, 5 corresponding to moderate risk, and 10 corresponding to maximum risk. The maximum risk and the minimum risk comprises an evaluation of one or more factors such as environmental factors, production factors, safety factors, and financial factors. Other examples of risk factors are possible.

Based upon the monitored first characteristic, a current risk at which the first industrial asset 102 is operating, as well as a location on the scale representing the current risk at which the first industrial asset 102 is operating are determined. The current risk may be presented on the scale to the user at the graphical display 116 of the user device 112. The current risk is then dynamically re-calculated and the location on the scale of the current risk at which the first industrial asset 102 is operating is adjusted as new values of the first characteristic are received. In some aspects, the current risk of the asset is rendered as a visual icon (e.g., a square, circle or star on the graphic display 116) to a user on the continuous scale of risk values.

In some aspects, a second characteristic of the second industrial asset 104 is also monitored, and it is determined where on the scale the second asset 104 is operating. This location may also be rendered on the scale to the user.

An action is then taken based upon the location of the current risk on the scale. In one example, taking the action comprises prioritizing taking a first action with respect to the first industrial asset 102 and a second action with respect to the second industrial asset 104.

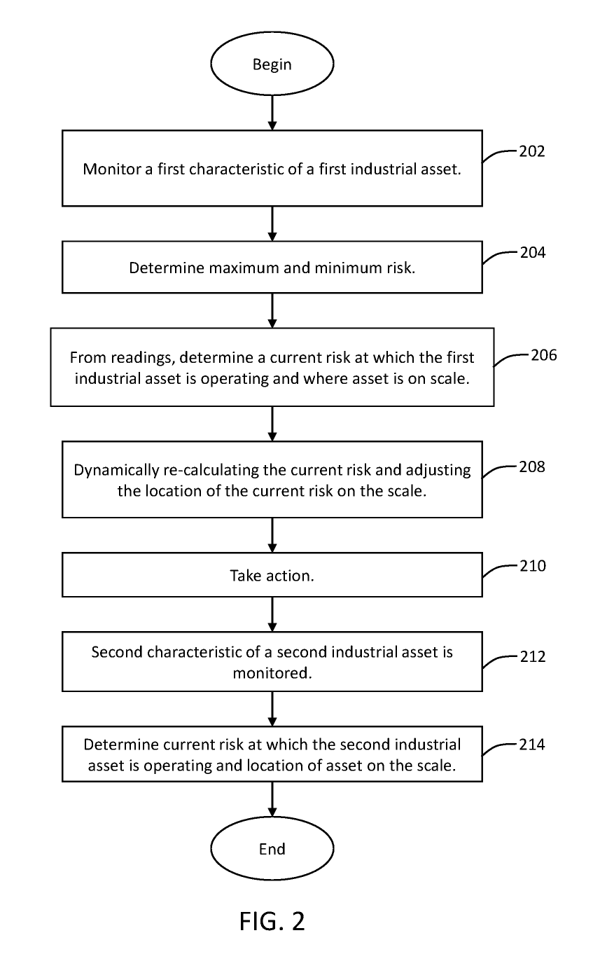

Referring now to FIG. 2, one example of an approach for dynamically determining and displaying the risk associated with the operation of industrial assets is described. In this example, an asset (e.g., an industrial machine) couples to a network, and the network is coupled to a central processing center. A user display device is also coupled to the network. The user display device may be deployed near the machine (e.g., at an installation where the machine is deployed), or remotely from the machine. In some cases, the user display device may be deployed at the central processing center.

At step 202, a first characteristic of a first industrial asset is monitored at the central processing center. In aspects, dynamic real time data is received at the central processing center (e.g., from the asset) and used, at least in part, to determine a risk assessment for the asset. The real time data received indicates a first characteristic of the asset. For instance, sensed temperature data from a reactor indicating temperatures that are trending higher (e.g., towards a predetermined critical temperature threshold) may be received continuously (and in real time) from a sensor connected to an asset.

At step 204, a maximum risk associated with failure of the first industrial asset and a minimum risk associated with failure of the first industrial asset are determined. The maximum risk and the minimum risk define a continuous scale. In one example, the continuous scale has integer tick mark labels from 0 to 10, with 0 corresponding to minimum risk of asset failure, 5 corresponding to moderate risk, and 10 corresponding to maximum risk.

At step 206 and based upon the monitored first characteristic, a current risk at which the first industrial asset is operating and a location on the scale representing the current risk at which the first industrial asset is operating are determined. For example, the sensed temperature value (i.e., the reactor temperature in this example) is mapped to a risk scale value. The risk values themselves need not be integer or half-integer values. For example, a reactor core temperature of 1000° C. may map to a scale value of 3.2, therefore lying between the “3” and “4” integer tick mark labels on the continuous scale. In another example, a sensed temperature value of 2000° C. for a nuclear reactor may correspond to maximum risk, since such a temperature may result in core meltdown. The current risk may then be displayed on the scale to a user (e.g., as an icon on the scale).

At step 208, the current risk and the location on the scale of the current risk (at which the first industrial asset is operating) are dynamically re-determined and adjusted as new values of the first characteristic are received. In examples, a characteristic, such as reactor temperature, may initially be mapped to a value on the continuous scale corresponding to moderate risk. At a later time, the sensed temperature data indicate that the temperature has increased, and now maps to a value on the continuous scale corresponding to maximum risk. Other examples are possible.

At step 210, an action is taken based upon the location of the current risk on the scale. Referring to the example above, the current sensed temperature value maps to a scale value corresponding to maximum risk, therefore an action to shut down the reactor is taken. In another example, if the sensed temperature value maps to a scale value corresponding to moderate risk, an action to send an alert to the user may be taken. Still other examples are possible.

At step 212, a second characteristic of a second industrial asset is monitored. In the same manner as the first asset, dynamic real time data is received at the central processing center (e.g., from the second asset) and used, at least in part, to determine a risk assessment for the second asset. Real time data received indicates a second characteristic of the second asset.

At step 214 and based upon the monitored second characteristic, the current risk of where the second industrial asset is determined and a location on the scale of the current risk of where the second asset is operating are also determined. Steps 204-210 are carried out for the second asset in the same manner as for the first asset. Further, installations may have two or more than two assets in operation, and it is desired to perform dynamic real-time risk assessment for each asset. Further still, the assets may not be fully independent, such that the performance of a given asset may be influenced by the performance of one or more other assets of the installation.

In examples, risk assessments are presented to users who may weigh whether a machine is likely to fail (e.g., using a numeric scale), and whether the component is sensitive or delicate (e.g., whether the component is susceptible to easy breakage because of its size or composition). In other examples, risk assessments involve the consequences of machine or component failure. For instance, failure of the component may cause the machine to fail. In yet other examples, failure of the machine may cause an entire process to cease functioning (e.g., shutdown an entire assembly line or reactor). These determinations may also be made automatically by electronic circuitry.

Referring now to FIG. 3, one example of an apparatus 300 that determines risk and displays this to a user is described. The apparatus includes and interface 302, a database 304, and a control circuit 306.

The interface 302 has an input 308 and an output 310. The input 308 is configured to receive a first characteristic of a first industrial asset that is monitored by a first sensor. Further, the input 308 is configured to receive a second characteristic of a second industrial asset that is monitored by a second sensor. The input 308 may also be configured to receive additional characteristics from either the first industrial asset, the second industrial asset, or both the first and second industrial assets.

The database 304 is configured to store a data structure. The data structure includes a maximum risk associated with failure of the first industrial asset and a minimum risk associated with failure of the first industrial asset. The maximum risk and the minimum risk define a continuous scale. For example, the continuous scale may be a numerical value from 0 to 10, with 0 representing the minimum risk associated with failure of the first industrial asset and 10 representing the maximum risk associated with failure of the first industrial asset. Other scales may be used. The database 304 is any type of memory storage device.

The control circuit 306 is coupled to the interface 302 and the database 304. The control circuit 306 is configured to, based upon the monitored first characteristic, determine a current risk at which the first industrial asset is operating and a location on the scale representing the current risk. The control circuit may render the current risk on the scale to a user via the output 310 of the interface 302. The control circuit 306 is further configured to dynamically re-calculate the current risk and adjust the location on the scale of the current risk at which the first industrial asset is operating as new values of the first characteristic are received at the input of the interface. The control circuit 306 is configured to determine an action based upon the placement of the current risk on the scale. The action is communicated to a user via the output 310 of the interface 302. For example, the output 310 communicated to the user may be a graphical display of the location of the asset on the continuous risk scale. The control circuit 306 may be any combination of electronic hardware or software. In one example, the control circuit 306 may be a microprocessor that executes computer instructions.

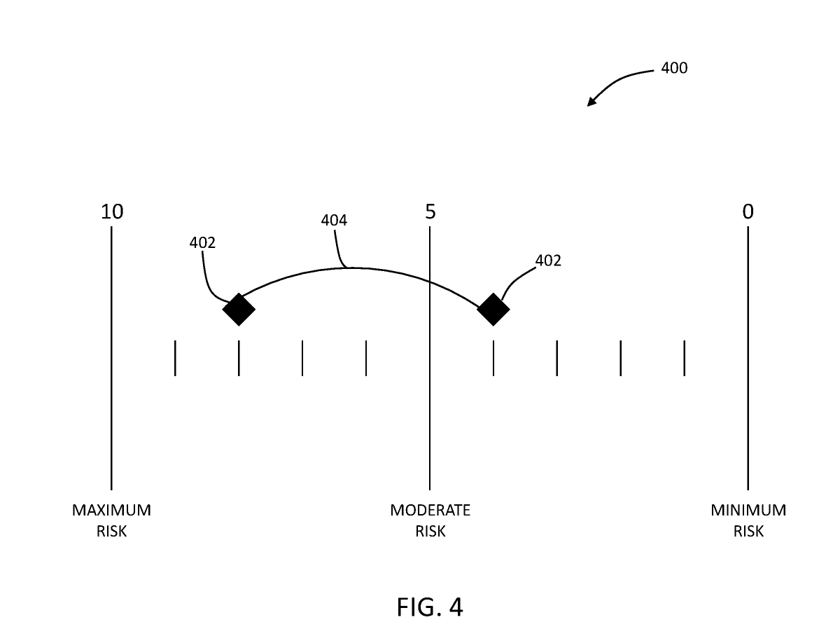

Referring now to FIG. 4, one example of a risk scale 400 is described. The scale is a continuous scale with values ranging from 0 to 10. 0 represents minimum risk, 5 represents moderate risk, and 10 represents maximum risk. To give one example and in the context of the operation of a nuclear power plant reactor, 0 represents normal operation of the reactor, 5 represents the reactor operating with some concerns, and 10 represents a meltdown of the reactor.

An icon 402 is displayed on the scale. The icon 402 represents the risk associated with failure of an asset based on a characteristic of the asset. The characteristic (e.g., temperature of the reactor) changes in time as new data is processed, thus the icon 402 moves from a first position to a second position in the direction indicated by the arrow labeled 404. Other parameters may also be monitored to determine the position of the icon 402 on the scale.

Initially and in the first position, the risk is approximately 4, while at a later time the icon 402 is in the second position, and the risk is approximately 8. The scale 400 may be rendered on a graphical display (e.g., graphical display 116 of FIG. 1) to a user. In this way, the user can quickly ascertain the degree of risk and may take actions based upon their perception of the risk. For example, if an icon increases in risk, but then at a later time decreases in risk, a user may decide to not take action. In other examples, automatic actions can be taken. In this example, if the risk exceeds a predetermined number (e.g., 9), then the reactor may be automatically shut down.

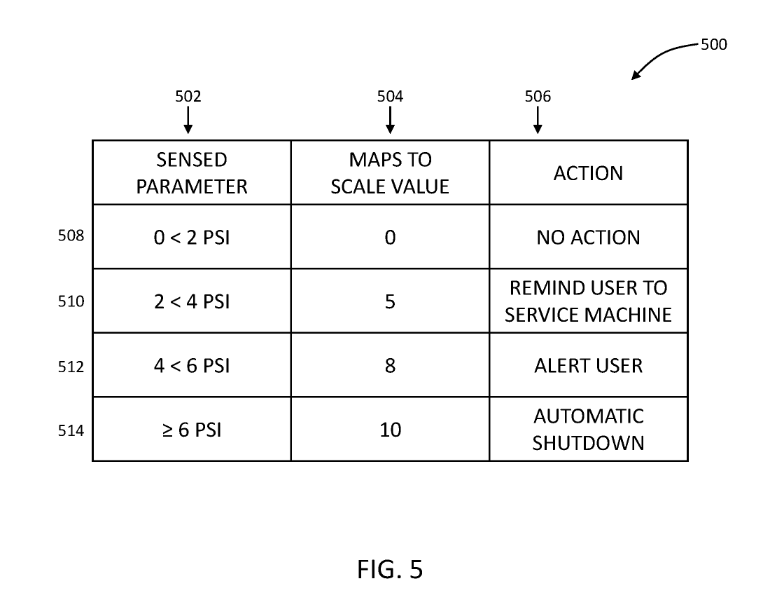

Referring now to FIG. 5, one example of an approach for converting sensed or monitored readings of parameters of industrial machines into scaled values and including actions is described. The approach is implemented in a table 500, which defines a mapping between a sensed parameter 502, a scale value 504, and an action 506. In this example, a machine has an internal pressure measured by a sensor in units of pounds per square inch (PSI).

A first row 508 specifies that sensed values of PSI between 0 and less than 2 are mapped to a scale value of 0 and no action is taken. A second row 510 specifies that sensed values of PSI between 2 and less than 4 are mapped to a scale value of 5 and the action is to send an electronic message to a user to remind the user to service the machine. A third row 512 specifies that sensed values of PSI between 4 and less than 6 are mapped to a scale value of 8 and the action taken is to send an electronic alert to the user to take immediate action. A fourth row 514 specifies that sensed values of PSI greater than or equal to 6 are mapped to a scale value of 10 and that the action taken is to automatically shut down the machine.

It will be appreciated that the example of FIG. 5 is only one example of an approach to convert sensed readings into values that can be displayed on a scale to users. Other sensed values may also be considered. In this case, a weighted sum of values may be calculated and this is converted to a scaled value. For example, temperature and rotational speed may also be measured. In this case, pressure, temperature, and rotational speed may be summed together with each component in the equation being weighted according to the importance attached to the component. The weighted sum may then be mapped to a scale value and associated with an action.

In the example of FIG. 5, one type of data structure (a mapping table) is described. However, it will be appreciated that other programming structures can also be used.

In still other examples, the mapping may utilize one or more equations or other relationships to map sensed values to risk factors. For example, a linear equation may be used to map sensed values of from 0-20 psi to risk factors of 0 to 10. Any sensed value at or exceeding 20 psi is mapped to 10 in this particular example.

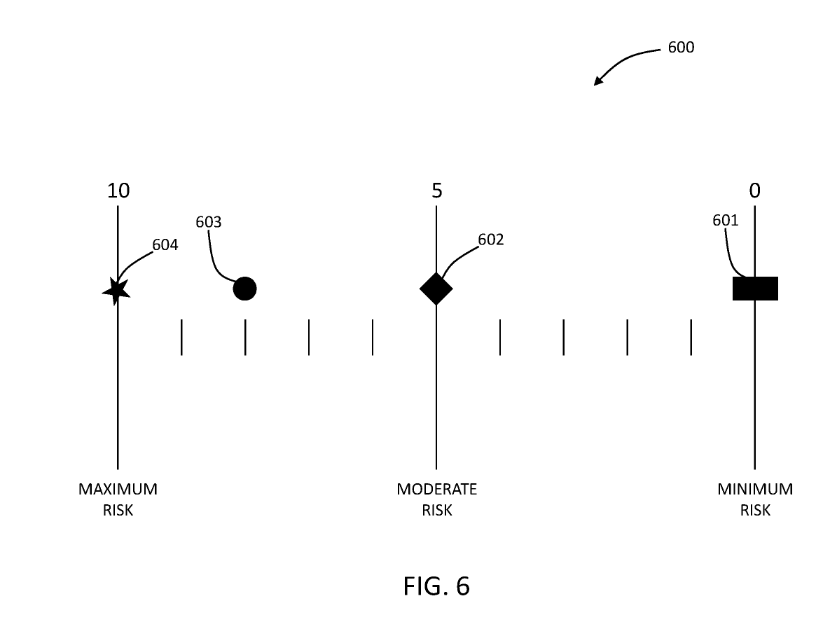

Referring now to FIG. 6, another example of a risk scale 600 is described. Similar to FIG. 4, the scale is a continuous scale from 0 to 10 with integer tick marks. 0 represents minimum risk, 5 represents moderate risk, and 10 represents maximum risk. In FIG. 6, multiple icons representing multiple assets are shown at one snapshot in time.

Using the mapping shown in the example of FIG. 5, a characteristic of pressure for 4 machines is measured. A first machine represented by the rectangular icon 601 has a pressure of 1 psi, which maps to a risk scale value of 0, and no action is required for the machines. A second machine represented by the diamond icon 602 has a pressure of 3 psi, which maps to a risk scale value of 5, and a reminder to service the machine may be sent to a user. A third machine represented by the circle icon 603 has a pressure of 5 psi, which maps to a risk scale value of 8, and an alert is issued to the user. A fourth machine represented by the star icon 602 has a pressure of 7 psi, which maps to a risk scale value of 10. In this instance, an automatic shutdown occurs.

In other examples, more than four machines may be monitored or less than four may be monitored. In still other examples, the icons may represent a different characteristic related to the machines, such as temperature.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method, comprising:
monitoring a first characteristic of a first industrial asset;
determining a maximum risk associated with failure of the first industrial asset and a minimum risk associated with failure of the first industrial asset, the maximum risk and the minimum risk defining a continuous scale;
based upon the monitored first characteristic, determining a current risk at which the first industrial asset is operating and a location on the scale representing the current risk at which the first industrial asset is operating, and presenting the current risk on the scale to a user;
dynamically re-calculating the current risk and adjusting the location on the scale of the current risk at which the first industrial asset is operating as new values of the first characteristic are received;
taking an action based upon the location of the current risk on the scale.

2. The method of claim 1, further comprising:
monitoring a second characteristic of a second industrial asset;
based upon the monitored second characteristic, determining where on the scale the second asset is operating.

3. The method of claim 1, wherein taking the action comprises prioritizing taking a first action with respect to the first industrial asset and a second action with respect to the second industrial asset.

4. The method of claim 1, wherein the current risk of the asset as applied to the scale is rendered as a visual icon to a user.

5. The method of claim 1, wherein determining the maximum risk and the minimum risk comprises an evaluation of one or more factors selected from the group consisting of: environmental factors, production factors, safety factors, and financial factors.

6. The method of claim 1, wherein the first asset is an industrial machine deployed in a factory.

7. The method of claim 1, wherein the first characteristic is selected from the group consisting of: a speed, a pressure, a dimension, a temperature, and a time.

8. An apparatus, comprising:
an interface having an input and an output, the input being configured to receive a first characteristic of a first industrial asset that is monitored by a first sensor;
a database that is configured to store a data structure, the data structure including a maximum risk associated with failure of the first industrial asset and a minimum risk associated with failure of the first industrial asset, the maximum risk and the minimum risk defining a continuous scale;
a control circuit that is coupled to the interface, the control circuit being configured to, based upon the monitored first characteristic, determine a current risk at which the first industrial asset is operating and a location on the scale representing the current risk at which the first industrial asset is operating, and to present the scale and the current location to a user at the output of the interface, the control circuit further configured to dynamically re-calculate the current risk and adjust the location on the scale of the current risk at which the first industrial asset is operating as new values of the first characteristic are received at the input of the interface, wherein the control circuit is configured to determine an action based upon the placement of the current risk on the scale, the action being communicated to a user via the output of the interface.

9. The apparatus of claim 8, where the input of the interface receives a second characteristic of a second industrial asset that is monitored by a second sensor and wherein the control circuit is configured to, based upon the monitored second characteristic, determine where on the scale the second asset is operating.

10. The apparatus of claim 9, wherein the control circuit is configured to prioritize taking a first action with respect to the first industrial asset and a second action with respect to the second industrial asset.

11. The apparatus of claim 8, wherein the current risk of the asset as applied to the scale is rendered as a visual icon to a user at an electronic display coupled to the output of the interface.

12. The apparatus of claim 8, wherein the maximum risk and the minimum risk are based upon an evaluation of one or more factors selected from the group consisting of: environmental factors, production factors, safety factors, and financial factors.

13. The apparatus of claim 8, wherein the first asset is an industrial machine deployed in a factory.

14. The apparatus of claim 13, wherein the first characteristic is selected from the group consisting of: a speed, a pressure, a dimension, a temperature, and a time.
